(19) United States
(12) Patent Application Publication
(10) Pub. No.: US 2025/0125393 A1
(43) Pub. Date: Apr. 17, 2025

(54) HIGH HYDROGEN UTILIZATION FUEL CELL SYSTEM

(71) Applicant: FuelCell Energy, Inc., Danbury, CT (US)

(72) Inventor: Jonathan MALWITZ, Danbury, CT (US)

(21) Appl. No.: 18/671,296

(22) Filed: May 22, 2024

Related U.S. Application Data
(60) Provisional application No. 63/503,997, filed on May 24, 2023.

(51) Int. Cl. H01M 8/0662; B01D 53/22; B01D 53/26; B01D 53/32; H01M 8/04014; H01M 8/04119; H01M 8/0444; H01M 8/04746

(52) U.S. Cl. CPC H01M 8/0681; B01D 53/228; B01D 53/268; B01D 53/326; H01M 8/04014; H01M 8/04164; H01M 8/04462; H01M 8/04761; H01M 8/0687; B01D 2053/221

(57) ABSTRACT

A fuel cell system includes a fuel cell module including an anode portion and a cathode portion. The anode portion is configured to generate an anode exhaust stream that includes hydrogen, nitrogen, and steam. The system further includes a membrane dryer configured to receive the anode exhaust stream, remove steam from the anode exhaust stream, and output a dried anode exhaust stream including hydrogen and nitrogen. The system further includes an electrochemical hydrogen separator configured to receive at least a first portion of the dried anode exhaust stream, to separate hydrogen from nitrogen contained in the dried anode exhaust stream, and to generate a hydrogen stream including the separated hydrogen. The anode portion of the fuel cell module is configured to receive an anode input stream including the hydrogen stream.

### CROSS-REFERENCE TO RELATED PATENT APPLICATION

This application claims the benefit of and priority to U.S. Provisional Patent Application No. 63/503,997, filed May 24, 2023, which is incorporated by reference herein in its entirety.

### BACKGROUND

The present invention relates generally to the field of electrochemical cells, such as fuel cells (e.g., solid oxide fuel cells), and more particularly to increasing the utilization of hydrogen fuel in a fuel cell system.

Generally, a fuel cell is a type of electrochemical cell that includes an anode, a cathode, and an electrolyte layer that together drive chemical reactions to produce electricity. Multiple fuel cells may be coupled together (e.g., arranged in a stack) to produce a desired amount of electricity. Fuel gas, such as hydrogen gas, is supplied to the anode, while oxidant gas is supplied to the cathode. The fuel gas and oxidant gas are consumed in the electrochemical reactions as they flow over the anode and cathode, respectively.

In order to ensure that there is sufficient hydrogen gas to operate the fuel cell system at optimal efficiency, more hydrogen gas may be supplied to the fuel cells than can be reacted in the fuel cell. Some hydrogen gas thus passes through and is expelled from the anode portion of the fuel cell without reacting. This unreacted hydrogen gas can be returned to the anode portion of the fuel cell system via an anode recycle stream. However, impurities, such as nitrogen, carbon dioxide, carbon monoxide, sulfur compounds, argon, helium, hydrocarbons, etc., can build up in the hydrogen gas as it is recycled repeatedly to the anode, which can reduce the efficiency of the system and the life span of the fuel cells. In existing systems, a portion of the recycle stream is purged to reduce the buildup of impurities. However, a portion of the hydrogen gas in the recycle stream is purged along with the impurities, reducing the fuel utilization of the system.

Accordingly, it would be advantageous to provide a system that separates hydrogen from the recycle stream before purging the impurities.

### SUMMARY

According to an aspect of the present disclosure, a fuel cell system is provided. The fuel cell system includes a fuel cell module including an anode portion and a cathode portion, the anode portion configured to generate an anode exhaust stream that includes hydrogen, nitrogen, and steam, a membrane dryer configured to receive the anode exhaust stream, remove steam from the anode exhaust stream, and output a dried anode exhaust stream that includes hydrogen and nitrogen, and an electrochemical hydrogen separator configured to receive at least a first portion of the dried anode exhaust stream, to separate hydrogen from nitrogen contained in the dried anode exhaust stream, and to generate a hydrogen stream including the separated hydrogen. The anode portion of the fuel cell module is configured to receive an anode input stream including the hydrogen stream.

In some embodiments, the anode input stream further includes a second portion of the dried anode exhaust stream. In some embodiments, the anode input stream further includes a fresh fuel gas stream including hydrogen. In some embodiments, the fuel cell system further includes a heat exchanger configured to transfer heat from the anode exhaust stream to the anode input stream before the anode portion of the fuel cell module receives the anode input stream. In some embodiments, the fuel cell system further includes a blower configured to pressurize the second portion of the dried anode exhaust stream.

In some embodiments, the membrane dryer includes a first chamber and a second chamber separated by a membrane. The first chamber is configured to receive the anode exhaust stream, and the second chamber is configured to receive a dry sweep gas stream to increase a steam removal rate of the membrane dryer. In some embodiments, the dry sweep gas stream includes unreacted oxidant that is output by the cathode portion of the fuel cell module.

In some embodiments, the membrane dryer is a perfluorosulfonic acid ion-exchange moisture exchanger.

In some embodiments, the electrochemical hydrogen separator includes a proton-exchange membrane electrochemical cell. In some embodiments, the proton-exchange membrane electrochemical cell is a high temperature proton-exchange membrane electrochemical cell configured to operate at temperatures between about 140 degrees Celsius and about 200 degrees Celsius.

In some embodiments, the electrochemical hydrogen separator is configured to output an EHS exhaust stream for removal from the fuel cell system, the EHS exhaust stream including nitrogen from the first portion of the dried anode exhaust stream. In some embodiments, the fuel cell system further includes at least one valve assembly and a controller configured to operate the at least one valve assembly to control a percentage of the dried anode exhaust stream that is directed to the electrochemical hydrogen separator based on a target removal rate of nitrogen from the fuel cell system. In some embodiments, the fuel cell system further includes a hydrogen concentration sensor configured to detect a hydrogen concentration of the anode exhaust stream or the dried anode exhaust stream, wherein the controller is configured to determine the target removal rate of nitrogen based on the hydrogen concentration.

In another aspect of the present disclosure, a method of operating a fuel cell system is provided. The method includes removing steam from an anode exhaust stream that is output from an anode portion of a fuel cell module to generate a dried anode exhaust stream, separating hydrogen from at least a first portion of the dried anode exhaust stream to generate a hydrogen stream, and directing the hydrogen stream into the anode portion of the fuel cell module.

In some embodiments, the method further includes directing a second portion of the dried anode exhaust stream into the anode portion of the fuel cell module. In some embodiments, the method further includes pressurizing the second portion of the dried anode exhaust stream and combining the pressurized second portion of the dried anode exhaust stream with the first portion of the dried anode exhaust stream.

In some embodiments, the method further includes heating the hydrogen stream using the anode exhaust stream.

In some embodiments, separating hydrogen from the at least the first portion of the dried anode exhaust stream includes providing the at least the first portion of the dried anode exhaust stream to an electrochemical hydrogen separator to separate the hydrogen and generate a residual stream including nitrogen.

In some embodiments, the method further includes expelling the residual stream from the fuel cell system. In some embodiments, the method further includes detecting or estimating a concentration of nitrogen in the dried anode exhaust stream and determining a percentage of the dried anode exhaust stream from which hydrogen is separated based on the detected or estimated concentration of nitrogen in the dried anode exhaust stream.

### BRIEF DESCRIPTION OF THE DRAWINGS

FIG. 1 is a schematic diagram of a fuel cell system, according to an exemplary embodiment.

FIG. 2 is a schematic diagram of a membrane dryer used in the fuel cell system of FIG. 1, according to an exemplary embodiment.

FIG. 3 is a flow diagram of a method of cooling a vaporizer in a fuel cell system, according to an exemplary embodiment.

It will be recognized that the figures are the schematic representations for purposes of

illustration. The figures are provided for the purpose of illustrating one or more implementations with the explicit understanding that the figures will not be used to limit the scope of the meaning of the claims.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

According to an exemplary embodiment, a fuel cell system is provided that separates hydrogen from impurities in an anode exhaust stream before recycling the separated hydrogen to an anode portion of a fuel cell system. The anode exhaust stream is dried by a membrane dryer and separated into two portions. One portion may be directed to an electrochemical hydrogen separator, where the hydrogen is separated from impurities. The separated hydrogen is then recombined with the other portion of the dried anode exhaust stream and a fresh hydrogen stream. This combined fuel stream is returned to the anode portion. Using this method, hydrogen can be recycled for use in the fuel cells, while impurities can be removed from the system. This may improve the fuel utilization rate while optimizing the efficiency and increasing the life span of the fuel cells. Unlike using a condenser to dry the anode exhaust stream, using a membrane dryer does not require cooling of the anode exhaust stream below the condensation point of water. Thus, less heating of the recycled exhaust is required when it is returned to the anode portion of the fuel cell module.

During operation of a fuel cell system, fresh hydrogen gas, as well as recycled hydrogen gas from an anode recycle stream, may be supplied to the anode portion of the fuel cell stacks. As hydrogen is consumed in the reactions in the fuel cells and steam is formed, the proportion of nitrogen, steam, and other impurities increases. When the anode exhaust is repeatedly recycled back to the anode inlet stream and combined with the fresh hydrogen gas feed, the nitrogen, steam, and other impurities can build up, diluting the hydrogen gas and reducing the efficiency of the system. A portion of the nitrogen, steam, and other impurities in the anode recycle stream can be continuously purged from the system so that the percentage of hydrogen remains above a desired threshold. However, some hydrogen gas is usually purged along with the nitrogen, steam, and other impurities. In order to increase the utilization of hydrogen gas in a fuel cell system, it is advantageous to separate the hydrogen gas from the nitrogen, steam, and other impurities, so that a lower amount of hydrogen is purged along with the nitrogen and other impurities and a higher percentage of hydrogen is returned to the anode portion.

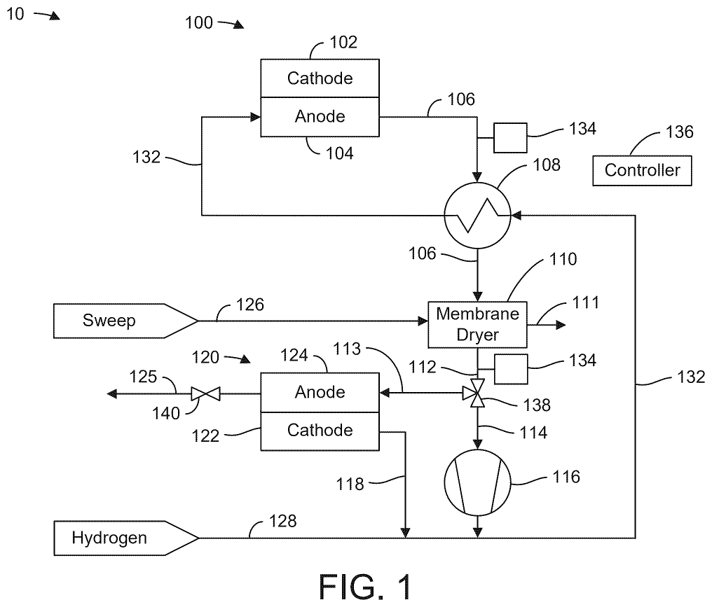

Referring to FIG. 1, a schematic diagram of a fuel cell system 10 is shown according to an exemplary embodiment. The fuel cell system 10 includes a fuel cell module 100, which may include one or more fuel cells. As illustrated, the fuel cell module is shown to include a cathode portion 102 and an anode portion 104, although it should be understood by those reviewing the present disclosure that in cases where multiple fuel cells are provided as part of the fuel cell module, each of the individual fuel cells will have its own cathode portion and anode portion. According to an exemplary embodiment, the fuel cell module 100 may be a solid oxide fuel cell module and may include one or more fuel cells, which may be arranged in one or more stacks.

The anode portion 104 receives fuel gas (e.g., hydrogen gas) from an anode input stream 132 and the cathode portion 102 receives an oxidant (e.g., air). At each fuel cell in the fuel cell module 100, an electrical current is generated as oxygen ions from the oxidant move through the electrolyte from the cathode portion 102 to the anode portion 104. The oxygen ions bond with hydrogen atoms from the anode input stream 132 to form steam. At the same time, the anode portion 104 outputs an anode exhaust stream 106. To ensure that there is sufficient hydrogen gas to operate the fuel cell system 10 at optimal efficiency, more fuel gas may be supplied to the fuel cells than can be reacted in the fuel cell before being expelled in the anode exhaust stream 106. Thus, some fuel gas passes through the fuel cell system without reacting. This unreacted hydrogen gas can be recycled to the anode input stream 132 of the fuel cell system to improve fuel utilization. The anode exhaust stream 106 may also include nitrogen and other impurities that cross over from the cathode portion 102 to the anode portion 104 through cracks and pores in the fuel cell electrolytes. Because of this, the anode exhaust stream 106 may contain unreacted hydrogen, steam, nitrogen, and other impurities. As the fuel cell module 100 ages, more cracks may develop, leading to more crossover of impurities. A buildup of impurities in the anode input stream due to repeated recycling can reduce the efficiency of the fuel cell system 10 and the life span of the fuel cells.

To remove nitrogen, steam, and other impurities from the anode exhaust stream 106, a portion of the anode exhaust stream 106 may be purged from the system 10. However, purging of a portion of the recycle stream can also result in the purging of unreacted fuel gas, which reduces the fuel utilization rate and efficiency of the fuel cell system 10. To decrease the amount of hydrogen purged along with the nitrogen, steam, and other impurities, a membrane dryer 110 is used to first remove steam from the anode exhaust stream 106, and then an electrochemical hydrogen separator (EHS) 120 is used to separate the hydrogen from the nitrogen and other impurities.

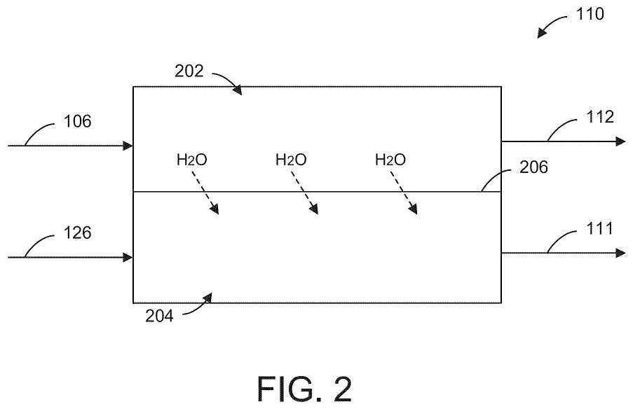

First, the anode exhaust stream 106 is directed toward, received by, and dried using a membrane dryer 110. FIG. 2 shows a schematic diagram of the membrane dryer 110, according to some embodiments. The membrane dryer 110 may be, for example, a moisture exchanger, such as a perfluorosulfonic acid ion-exchange moisture exchanger. In some embodiments, the membrane dryer 110 may include a hydrocarbon membrane or a microporous membrane. Other types of membrane dryers now known or which may be developed in the future may also be used.

In the embodiment shown in FIG. 2, the anode exhaust stream 106 may be directed to and received in a first chamber 202 of the membrane dryer 110. The steam in the anode exhaust stream 106 may pass through a steam-permeable membrane 206 in the membrane dryer 110 into a second chamber 204. The membrane 206 may not allow the other gases in the anode exhaust stream 106 to pass through to the second chamber 204. The steam may exit the second chamber 204 and be removed from the fuel cell system 10 via an outlet (illustrated as a steam exhaust stream 111). The first chamber 202 of the membrane dryer 110 may then output a dried anode exhaust stream 112 having a lower concentration of steam than the anode exhaust stream 106. A dry sweep gas stream 126 can be directed to and received in the second chamber 204 to increase the steam removal rate by sweeping steam out of the second chamber 204. This may reduce the concentration of steam in the second chamber 204, which may in turn increase the rate of steam passing through the membrane 206 from the first chamber 202 to the second chamber 204 and thus the amount of steam removal from the anode exhaust stream 106. The dry sweep gas stream 126 may include dry gas from the fuel cell air-drying system, gas from another dry gas source, and/or the unreacted oxidant that is exhausted from the cathode portion 102 of the fuel cell module 100.

In existing systems, condensers may be used to condense and remove water from an anode exhaust stream before the anode exhaust stream is recycled. However, using a condenser to remove the water requires that the anode exhaust stream is cooled to or below the condensation temperature of water. Using a membrane dryer 110 instead of a condenser allows for the removal of moisture from the anode exhaust stream 106 without the need to cool the anode exhaust stream 106 to or below the condensation temperature of water.

The dried anode exhaust stream 112 is split into a first portion 113 and a second portion 114. The first portion 113 of the dried anode exhaust stream 112 is directed into an anode portion 124 of the EHS 120. The EHS 120 may be, for example, a high temperature proton-exchange membrane (PEM) electrochemical cell to which an electrical current with a relatively low voltage is applied. For example, the voltage may be about 100-200 millivolts, while operating the PEM cell as an electrolyzer may require about 800 millivolts. The electrical current causes hydrogen atoms that contact the anode to be oxidized into electrons and positively charged hydrogen ions (e.g., protons). The hydrogen ions pass through the electrolyte to the cathode portion 102, while the electrons travel through an external circuit to the cathode portion 102. The hydrogen ions are recombined with the electrons in the cathode portion 102 to reform hydrogen gas atoms. Other gases, such as nitrogen, do not split into electrons and positive ions in the presence of the anode, so only hydrogen is transported across the electrolyte.

High temperature PEM cells operate in the range of about 120 degrees Celsius to about 210 degrees Celsius, or about 160 degrees Celsius to about 180 degrees Celsius. In some embodiments, the high temperature PEM cell may include a polybenzimidazole or perfluorinated sulphonic acid polymer membrane and a phosphoric acid electrolyte. Unlike low temperature PEM cells, high temperature PEM cells do not require significant humidification of the membrane, so relatively dry input gases (e.g., the dried anode exhaust stream 112) can be used. Further, an EHS 120 incorporating a PEM cell does not require additional pressurization of the input gases above the process pressure of the rest of the system (e.g., the pressure of the first portion 113 of the dried anode exhaust stream 112), so additional blowers or compressors are not required. Compared to alternative devices, the EHS 120 provides a more efficient and moisture-tolerant method of separating hydrogen from the dried anode exhaust stream 112.

As discussed above, the first portion 113 of the dried anode exhaust stream 112 is supplied to the anode portion 124 of the EHS 120. The hydrogen in the first portion 113 is transported across the electrolyte of the EHS 120 to the cathode portion 122, which outputs a hydrogen stream 118 that is substantially pure hydrogen. It should be understood that the hydrogen stream 118 may contain small amounts of other gases (e.g., nitrogen, etc.) that may cross over to the cathode portion 122 through pores or cracks in the electrolyte. The remainder of the first portion 113 is exhausted from the anode portion 124 of the EHS 120 as EHS exhaust stream 125 (which may be referred to as a residual stream), which may be expelled and removed from the system 10. The EHS exhaust stream may contain nitrogen, other impurities, and a relatively small amount of hydrogen that did not cross the electrolyte of the EHS 120 to the cathode portion 122 of the EHS 120. The hydrogen stream 118 is then combined with a fresh fuel gas stream 128 comprising hydrogen, which replaces the hydrogen used up in the reactions in the fuel cell module 100. Thus, the EHS may separate hydrogen from nitrogen in the first portion 113 of the dried anode exhaust stream, though some hydrogen may remain in the EHS exhaust stream 125 and some nitrogen may be present in the hydrogen stream 118.

The second portion 114 of the dried anode exhaust stream 112 is input into a recycle blower 116, which pressurizes the second portion 114 and outputs the second portion 114 at a higher pressure to move the second portion 114 back toward the fuel cell module 100. The pressurized second portion 114 is combined with the hydrogen stream 118 and the fresh fuel gas stream 128 to form an anode input stream 132, which is directed into the anode portion 104 of the fuel cell module 100. The blower 116 provides upstream pressure to move anode input stream 132 downstream toward the anode portion 104 of the fuel cell module 100.

Before being input into the anode portion 104, the anode input stream 132 may first be directed to a heat exchanger 108. The anode exhaust stream 106 may also be directed to the heat exchanger 108, and heat from the anode exhaust stream 106 can be used to preheat the anode input stream 132 before it is input into the anode portion 104. The anode exhaust stream 106 is also cooled in the heat exchanger 108, which may reduce the downstream temperatures such that the efficiency of the membrane dryer 110 and EHS 120 are improved. It should be understood that the anode exhaust stream 106 and the anode input stream 132 pass through separate chambers of the heat exchanger 108 such that heat is exchanged, but the streams 106, 132 do not mix with each other.

The size, and therefore cost, of the EHS 120 may depend on the volume of gas to be processed. By using the membrane dryer 110 to remove steam from the anode exhaust stream 106, the EHS 120 receives a lower volume of gas than if the entire anode exhaust stream 106 was directed to the EHS 120. Further, by splitting the dried anode exhaust stream 112 into a first portion 113 and a second portion 114 and directing only the first portion 113 to the EHS 120, the volume of gas received by the EHS 120 is even smaller. The EHS 120 can therefore be sized much smaller than otherwise, driving significant cost savings. In some embodiments, the cathode portion 122 of the EHS 120 may be maintained at a higher pressure than the anode portion 124, for example, using a pressure control valve (e.g., downstream of the cathode portion 122 in the hydrogen stream 118) to control the pressure in the cathode portion 122. The increased pressure may improve the purity of the separated hydrogen and may prevent or reduce the amount of steam crossing over from the anode portion 124 to the cathode portion, further reducing the humidity of the gas returned to the anode portion 104 in the anode input stream 132.

The dried anode exhaust stream 112 can be split into the first and second portions 113, 114 in proportions such that the necessary amount of nitrogen and other impurities are expelled from the fuel cell system 10 by the EHS 120. For example, assuming ten percent of the nitrogen must continuously be removed from the dried anode exhaust stream 112 to maintain an acceptable level of nitrogen in the anode input stream, and assuming the EHS 120 is able to recover all of the hydrogen while expelling all of the nitrogen, the first portion 113 of the dried anode exhaust stream 112 may comprise ten percent of the dried anode exhaust stream 112, and the second portion 114 of the dried anode exhaust stream 112 may ninety percent of the dried anode exhaust stream 112. Thus, ten percent of the nitrogen will be expelled via the EHS exhaust stream 125, while the remaining ninety percent of the nitrogen bypasses the EHS 120 and is recirculated to the anode portion 104 via the blower 116 and the anode input stream 132. If it is determined that more nitrogen is accumulating, or that the concentration of another impurity in the dried anode exhaust stream 112 is increasing, the percentage of the dried anode exhaust stream 112 directed to the EHS 120 may be increased (e.g., the first portion 113 may be more than ten percent of the dried anode exhaust stream 112). If the levels of contaminants are all within an acceptable range, all of the dried anode exhaust stream may bypass the EHS and be returned to the anode portion 104 via the anode input stream (e.g., the second portion 114 may be one hundred percent of the dried anode exhaust stream 112). The rate of contaminant accumulation in the system can be affected by the amount of hydrogen added via the fresh fuel gas stream 128, the purity of the fresh fuel gas stream 128, the hydrogen utilization of the fuel cell module 100, the amount of water removed by the membrane dryer 110, the ratio of the first portion 113 to the second portion 114, and the efficiency of EHS 120 (e.g., how much the volume and purity of the hydrogen that crosses over to the cathode portion 122). The gas concentrations can be measured at various points in the system 10 to determine if the percentage of the dried anode exhaust stream 112 directed to the EHS 120 should be increased or decreased.

The proportions of the first and second portions 113, 114 can be adjusted based on a desired removal rate of nitrogen or other impurities from the dried anode exhaust stream 112. The desired removal rate may be determined based on detected or estimated concentrations of nitrogen or other impurities, or an estimated or measured hydrogen concentration, in the anode exhaust stream 106 or the dried anode exhaust stream 112. For example, a hydrogen concentration sensor 134 may be positioned near the outlet of the anode portion 104 to measure the hydrogen concentration in the anode exhaust stream 106, near the inlet of the anode portion 104 to measure the hydrogen concentration of the anode input stream, or near the outlet of the membrane dryer 110 to measure the hydrogen concentration of the dried anode exhaust stream 112. If the detected hydrogen concentration is below a desired hydrogen concentration, the removal rate of nitrogen and other impurities can be increased by increasing the percentage of the dried anode exhaust stream 112 that is directed to the electrochemical hydrogen separator 120 as the first portion 113. If the detected hydrogen concentration is above a desired hydrogen concentration, the removal rate of nitrogen and other impurities can be decreased by decreasing the percentage of the dried anode exhaust stream 112 that is directed to the electrochemical hydrogen separator 120 as the first portion 113. Because the EHS 120 may not be perfectly efficient in capturing hydrogen, it may be advantageous to minimize the percentage of the dried anode exhaust stream 112 directed to the first portion 113, to minimize the amount of hydrogen expelled from the system 10 to improve the fuel utilization. For example, if the detected levels of nitrogen and other impurities are below a threshold level for efficient operation of the fuel cell module 100, there may be no need to expel any gas from the system 10. The second portion 114 may therefore receive the entire dried anode exhaust stream 112. In other embodiments, the EHS 120 may receive the entire dried anode exhaust stream 112 (e.g., there may not be a second portion 114). Because the steam is removed from the anode exhaust stream 106 by the membrane dryer 110, the EHS 120 will still be required to process only a portion of the total volume of gas in the anode exhaust stream 106. To adjust the proportions of the first and second portions 113, 114, a controller 136 may receive gas concentration data from one or more sensors (e.g., sensor 134) and may instruct an actuator to adjust a vent or open or close a valve (e.g., partially) such that the amount of dried anode exhaust stream gas directed to each of the first and second portions 113, 114 is adjusted. For example, in some embodiments, one or more valve assemblies 138 may be located where the dried anode exhaust stream 112 splits into the first portion 113 and the second portion 114. In some embodiments, a valve assembly 140 in the EHS exhaust stream 125 may control how much (of e.g., the percentage of) the dried anode exhaust stream 112 is allowed to flow into the anode portion 124 of the EHS 120 via the first portion 113, for example, based on a target nitrogen removal rate or target impurity removal rate. The target nitrogen removal rate or target impurity removal rate may be based on the hydrogen concentration detected by the hydrogen concentration sensor or sensors 134. The controller 136 may include one or more processors and one or more memories that store instructions that, when executed by the one or more processors, cause the controller 136 to execute the functions described herein (e.g., receiving measurements from the sensors 134, controlling the valve assemblies 138, 140, etc.).

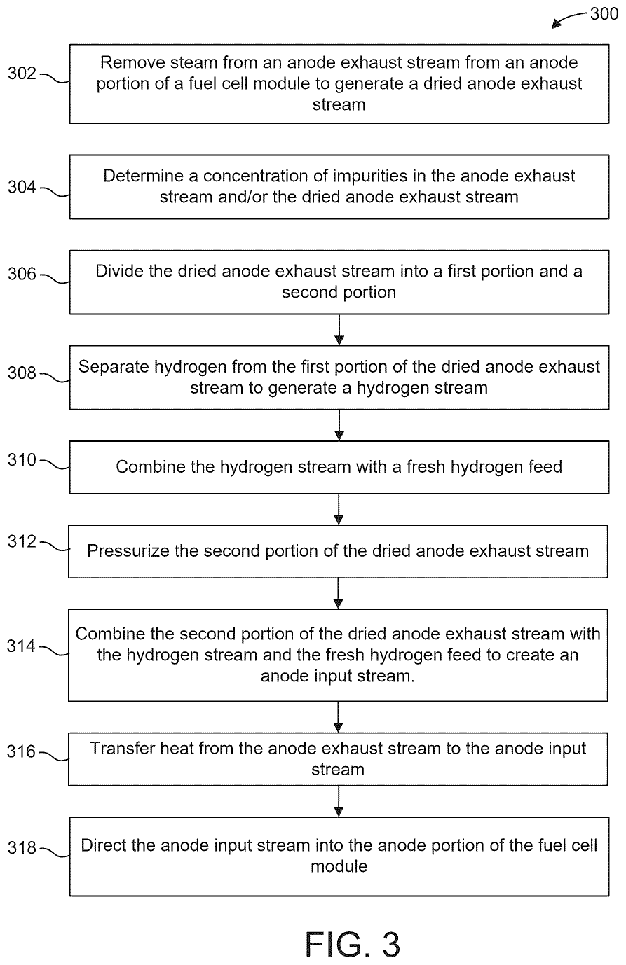

Referring now to FIG. 3, a method 300 of operating a fuel cell system (e.g., fuel cell system 10) is shown, according to an exemplary embodiment. In some embodiments, the method 300 may include additional operations or a subset of the listed operations. At operation 302 of the method 300, steam is removed from an anode exhaust stream from an anode portion of a fuel cell module to generate a dried anode exhaust stream. For example, in the fuel cell system 10, steam is removed from the anode exhaust stream 106 by the membrane dryer 110. In some embodiments, other types of dryers, including condensers, may be used to remove steam from the anode exhaust stream. However, it may be advantageous to use a dryer that is capable of drying the anode exhaust stream at higher temperatures, such as the membrane dryer 110.

At operation 304 of the method 300, the concentration of nitrogen and other impurities in the anode exhaust stream and/or the dried anode exhaust stream may be determined or estimated. For example, a hydrogen concentration sensor may measure the hydrogen concentration of the dried anode exhaust stream. For example, in the fuel cell system 10, the hydrogen concentration sensor 134 may be positioned near the outlet of the anode portion 104 and/or near the outlet of the membrane dryer 110. A hydrogen concentration of 90 percent may indicate that the dried anode exhaust stream contains 10 percent nitrogen and other impurities. At operation 306 the method 300, the dried anode exhaust stream may be divided into a first portion and a second portion. The dried anode exhaust stream may be divided based on the concentration of impurities in the dried anode exhaust stream (or the hydrogen concentration in the dried anode exhaust stream). If the concentration of impurities exceeds a desired concentration, the amount of dried anode exhaust in the first portion (from which hydrogen is separated from the impurities in operation 308) may be increased. For example, it may be determined based on the concentration of nitrogen and/or other impurities in the dried anode exhaust stream that ten percent of the impurities must be removed from the fuel cell system. The dried anode exhaust stream may then be divided such that the first portion includes ten percent of the dried anode exhaust stream, and the impurities in the first portion may be removed from the system at operation 308.

At operation 308 of the method 300, hydrogen may be separated from the first portion of the dried anode exhaust stream to generate a hydrogen stream. The hydrogen may be separated from nitrogen and other impurities in the first portion of the dried anode exhaust stream, and the nitrogen and other impurities may be expelled from the fuel cell system. For example, in the fuel cell system 10, hydrogen is separated from nitrogen and other impurities in the first portion 113 of the dried anode exhaust stream 112 by the EHS 120. In some embodiments, hydrogen can be separated by other methods, such as pressure swing adsorption. At operation 310 of the method 300, the hydrogen stream may be combined with a fresh hydrogen feed. For example, in the fuel cell system 10, the separated hydrogen stream 118 from the EHS 120 is combined with the fresh fuel gas stream 128.

At operation 312 of the method 300, the second portion of the dried anode exhaust stream may be pressurized, for example by a blower. For example, in the fuel cell system 10, the second portion 114 of the dried anode exhaust stream 112 is directed to and pressurized by the blower 116. At operation 314 of the method 300, the second portion of the dried anode exhaust stream is combined with the hydrogen stream and the fresh hydrogen feed to create an anode input stream. For example, in the fuel cell system 10, the second portion 114 of the dried anode exhaust stream 112 is output from the blower 116 and combined with the separated hydrogen stream 118 and the fresh fuel gas stream 128 to form the anode input stream 132. In some embodiments, the second portion of the dried anode exhaust stream, the hydrogen stream separated from the first portion of the dried anode exhaust stream, and the fresh hydrogen stream may be combined in any order.

At operation 316 of the method 300, heat is transferred from the anode exhaust stream to the anode input stream. For example, in the fuel cell system 10, heat is transferred from the anode exhaust stream 106 to the anode input stream 132 in the heat exchanger 108. At operation 318 of the method 300, the anode input stream is directed into the anode portion of the fuel cell module. For example, in the fuel cell system 10, the separated hydrogen stream 118 from the EHS 120, is combined with the second portion 114 of the dried anode exhaust stream 112 and the fresh fuel gas stream 128 to form the anode input stream 132, which is directed into the anode portion 104 of the fuel cell module 100. Upstream pressure from the blower 116 and the fresh fuel supply push the anode input stream 132 to the anode portion 104.

Using the method 300, steam, nitrogen, and other impurities in the anode exhaust stream can be removed, and purified hydrogen can be recycled to the fuel cell module. Heat from the anode exhaust stream can be used to preheat the hydrogen that is input into the anode portion. For example, in the fuel cell system 10, heat from the anode exhaust stream 106 can be used to heat the anode input stream 132 in the heat exchanger 108.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data that cause a general-purpose computer, special purpose computer, or special purpose processing machines to perform a certain function or group of functions.

Although the figures and description may illustrate a specific order of method steps, the order of such steps may differ from what is depicted and described, unless specified differently above. In some embodiments, methods may include additional steps or may omit recited steps. Also, two or more steps may be performed concurrently or with partial concurrence, unless specified differently above.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A fuel cell system comprising:
a fuel cell module comprising an anode portion and a cathode portion, the anode portion configured to generate an anode exhaust stream that comprises hydrogen, nitrogen, and steam;
a membrane dryer configured to receive the anode exhaust stream, remove steam from the anode exhaust stream, and output a dried anode exhaust stream that comprises hydrogen and nitrogen; and
an electrochemical hydrogen separator configured to receive at least a first portion of the dried anode exhaust stream, to separate hydrogen from nitrogen contained in the dried anode exhaust stream, and to generate a hydrogen stream comprising the separated hydrogen;
wherein the anode portion of the fuel cell module is configured to receive an anode input stream comprising the hydrogen stream.

2. The fuel cell system of claim 1, wherein the anode input stream further comprises a second portion of the dried anode exhaust stream.

3. The fuel cell system of claim 2, wherein the anode input stream further comprises a fresh fuel gas stream comprising hydrogen.

4. The fuel cell system of claim 2, further comprising a heat exchanger configured to transfer heat from the anode exhaust stream to the anode input stream before the anode portion of the fuel cell module receives the anode input stream.

5. The fuel cell system of claim 2, further comprising a blower configured to pressurize the second portion of the dried anode exhaust stream.

6. The fuel cell system of claim 1, wherein the membrane dryer comprises a first chamber and a second chamber separated by a membrane, wherein the first chamber is configured to receive the anode exhaust stream, and the second chamber is configured to receive a dry sweep gas stream to increase a steam removal rate of the membrane dryer.

7. The fuel cell system of claim 6, wherein the dry sweep gas stream includes unreacted oxidant that is output by the cathode portion of the fuel cell module.

8. The fuel cell system of claim 1, wherein the membrane dryer is a perfluorosulfonic acid ion-exchange moisture exchanger.

9. The fuel cell system of claim 1, wherein the electrochemical hydrogen separator comprises a proton-exchange membrane electrochemical cell.

10. The fuel cell system of claim 9, wherein the proton-exchange membrane electrochemical cell is a high temperature proton-exchange membrane electrochemical cell configured to operate at temperatures between about 140 degrees Celsius and about 200 degrees Celsius.

11. The fuel cell system of claim 1, wherein the electrochemical hydrogen separator is configured to output an EHS exhaust stream for removal from the fuel cell system, the EHS exhaust stream comprising nitrogen from the first portion of the dried anode exhaust stream.

12. The fuel cell system of claim 11, further comprising at least one valve assembly and a controller configured to operate the at least one valve assembly to control a percentage of the dried anode exhaust stream that is directed to the electrochemical hydrogen separator based on a target removal rate of nitrogen from the fuel cell system.

13. The fuel cell system of claim 12, further comprising a hydrogen concentration sensor configured to detect a hydrogen concentration of the anode exhaust stream or the dried anode exhaust stream, wherein the controller is configured to determine the target removal rate of nitrogen based on the hydrogen concentration.

14. A method of operating a fuel cell system, the method comprising:
removing steam from an anode exhaust stream that is output from an anode portion of a fuel cell module to generate a dried anode exhaust stream;
separating hydrogen from at least a first portion of the dried anode exhaust stream to generate a hydrogen stream; and
directing the hydrogen stream into the anode portion of the fuel cell module.

15. The method of claim 14, further comprising directing a second portion of the dried anode exhaust stream into the anode portion of the fuel cell module.

16. The method of claim 15, further comprising pressurizing the second portion of the dried anode exhaust stream and combining the pressurized second portion of the dried anode exhaust stream with the first portion of the dried anode exhaust stream.

17. The method of claim 14, further comprising heating the hydrogen stream using the anode exhaust stream.

18. The method of claim 14, wherein separating hydrogen from the at least the first portion of the dried anode exhaust stream comprises providing the at least the first portion of the dried anode exhaust stream to an electrochemical hydrogen separator to separate the hydrogen and generate a residual stream comprising nitrogen.

19. The method of claim 18, further comprising expelling the residual stream from the fuel cell system.

20. The method of claim 19, further comprising detecting or estimating a concentration of nitrogen in the dried anode exhaust stream and determining a percentage of the dried anode exhaust stream from which hydrogen is separated based on the detected or estimated concentration of nitrogen in the dried anode exhaust stream.
